(19) United States
(12) Patent Application Publication
(10) Pub. No.: US 2014/0048217 A1
(43) Pub. Date: Feb. 20, 2014

(54) CORD PROTECTION SLEEVE FOR CORDLESS BLINDS

(71) Applicants: SHENG YING HSU, Changhua County (TW); WU-CHUNG NIEN, Changhua (TW)

(72) Inventors: SHENG YING HSU, Changhua County (TW); WU-CHUNG NIEN, Changhua (TW)

(73) Assignee: CHING FENG HOME FASHIONS CO., LTD., Changhua County (TW)

(21) Appl. No.: 13/619,285

(22) Filed: Sep. 14, 2012

(30) Foreign Application Priority Data
Aug. 20, 2012 (TW) 101216004

(51) Int. Cl. E06B 9/30

(52) U.S. Cl. 160/173 R

(57) ABSTRACT

A cord protection sleeve of cordless blinds includes a tubular and flexible body and extends through the slats. The cord freely extends through the cord protection sleeve. The cord protection sleeve has a first end and a second end, wherein the first end is fixed to the head box and the second end is fixed to the bottom bar. The cord protection sleeve is secured to the support ropes supporting the slats. Because the cord protection sleeve is secured to the support ropes, it cannot be pulled away from the blinds, thereby preventing the cord from wrapping around the limbs of kids.

### FIELD OF THE INVENTION

The present invention relates to a cord protection sleeve for coreless transmission device of blinds, and more particularly, to a protection sleeve mounted to the cord of the blinds.

### BACKGROUND OF THE INVENTION

The conventional window curtains comprise roman shades, blinds and shutters, and the ways for operating the window curtains can be cataloged into cords operation and cordless operation. FIGS. 6 and 7 disclose cordless blinds 60 and comprise a head box 61 in which a cordless transmission device 70 is located. The blinds 60 are located between the head box 61 and a bottom bar 62 which is fixed to the last slat 63. The transmission device 70 comprises a mandrel 71 and two cords 75 each have one end wrapped to the mandrel 71 (one cord 75 is wrapped at the end 72 and the other cord 75 is wrapped to the position beside the right frame) and the other two respective ends of the two cords 75 extend through the head box and the slats 63, and are connected to the bottom bar 62. Two connection ropes 64, 65 are located on the front side and the rear side of the slats 63, and multiple support ropes 66 are transversely connected between the connection ropes 64, 65. The support ropes 66 respectively support the slats 63. When adjusting the blinds 60, the user holds the bottom bar 62 and moves the bottom bar 62 downward, the blinds 60 are pulled downward and the mandrel 71 of the cordless transmission device 70 is rotated by the movement of the two cords 75. The rope 711 has one end wrapped to the mandrel 71 and the other end of the rope 711 is wrapped to the scrolling unit 73. When the user holes the bottom bar 62 and pushes it upward, the scrolling unit 73 scrolls to rotate the mandrel 71 to warp the two cords 75 so that the blinds 60 are lifted.

However, the cord 75 is exposed between the slats 63 and kids may pull the cord 75 from the gaps between the slats 63. The cord 75 that is pulled away from the slats 63 may be wrapped around the kid's neck. If the cordless transmission device is activated while the cord 75 is wrapped around the kid's neck, the cord 75 may injure the kid.

The present invention intends to provide a cord protection sleeve and the cord freely extends through the sleeve. The sleeve is secured to the support ropes so that the sleeve and the cords cannot be pulled away from the slats.

### SUMMARY OF THE INVENTION

The present invention relates to cordless blinds and comprises a head box with a transmission device received therein. Multiple slats are located between the head box and a bottom bar which is connected with the lowest slat. A cord has a first end connected with the transmission device and a second end of the cord extends through the slats and is fixed to the bottom bar. Two connection ropes are respectively located on the front side and the rear side of each of the slats. Multiple support ropes are transversely connected between the two connection ropes. The support ropes are respectively located between the slats so as to support the slats. A cord protection sleeve comprises a tubular and flexible body and has a passage defined axially therethrough. The cord protection sleeve extends through the slats and the cord freely extends through the passage. The cord protection sleeve has a first end and a second end, wherein the first end is fixed to the head box and the second end is fixed to the bottom bar. The cord protection sleeve is secured to the support ropes.

The primary object of the present invention is to provide a cord protection sleeve for blinds and the cord freely extends through the cord protection sleeve. The cord protection sleeve extends through the slats and is secured to the support ropes of the slats so that the cord protection sleeve and the cord cannot be pulled out from the gaps of the slats.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the blinds with the cord protection sleeves of the present invention;

FIG. 2 is a perspective view to show a section of the cord protection sleeve of the present invention;

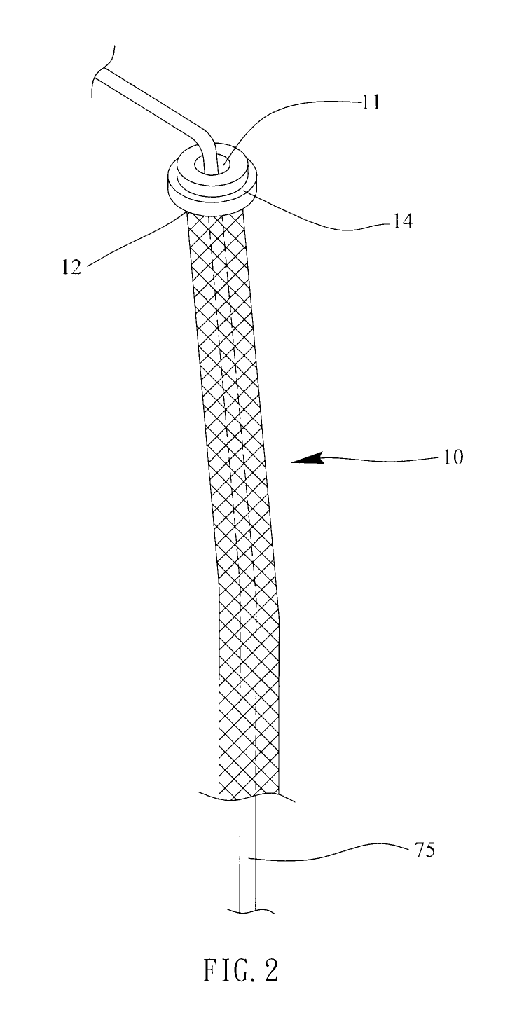

FIG. 3 is a side cross sectional view to show the blinds with the cord protection sleeves of the present invention;

FIG. 4 is a perspective view to show that the slats of the blinds are collected while the cord protection sleeves of the present invention are folded;

FIG. 5 is a side cross sectional view to show that when the slats of the blinds are collected, the cord protection sleeves of the present invention are folded;

FIG. 6 shows the conventional cords can be pulled away from the blinds, and

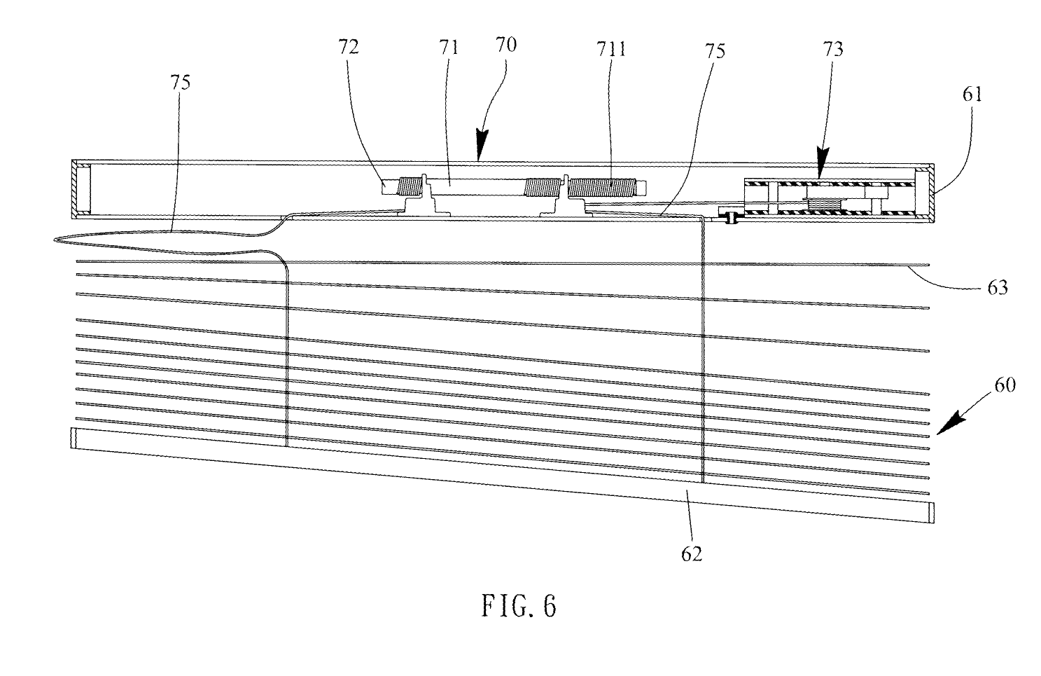

FIG. 7 is a side cross sectional view to show that the cord extends through the slats.

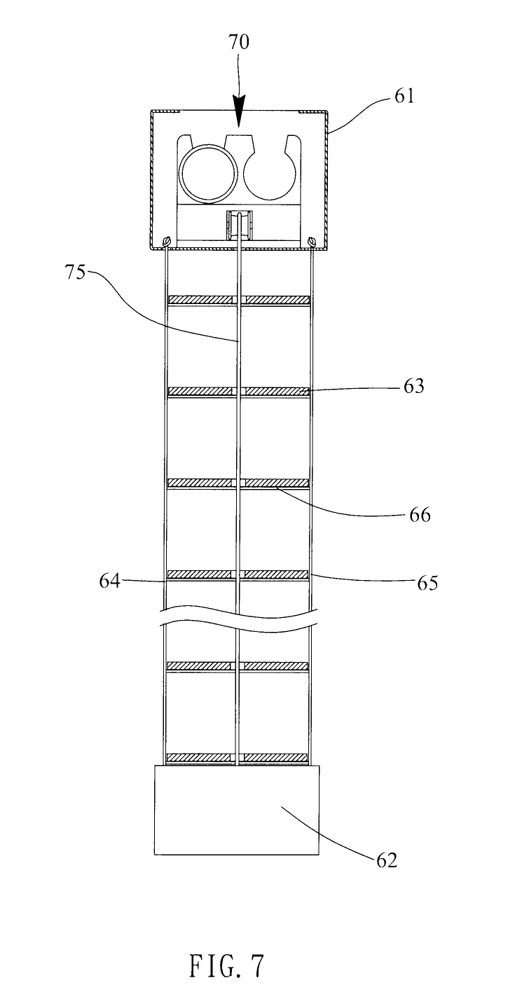

### DETAILED DESCRIPTION OF THE PREFERRED EMBODIMENT

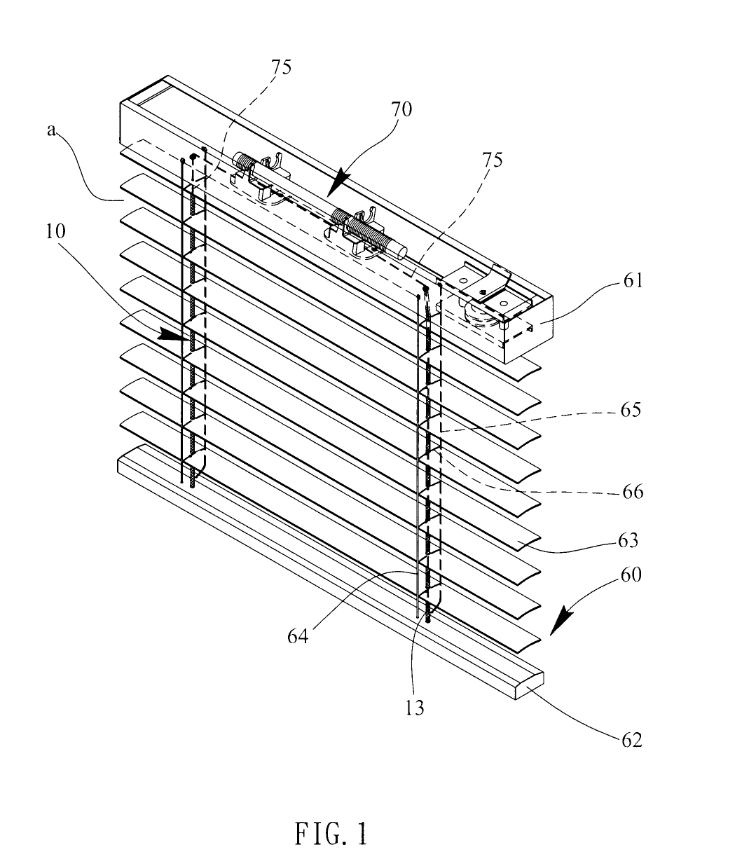

Referring to FIG. 1, the cordless blinds comprise a head box 61 and a transmission device 70 is received in the head box 61. Multiple slats 63 are located between the head box 61 and a bottom bar 62 which is connected with the lowest slat 63. Two cords 75 each have a first end connected with the transmission device 70 and a second end of the cord 75 extends through the head box 61 and the slats 63 and is fixed to the bottom bar 62. In detail, the first end of each of the cords 75 is wrapped to the mandrel of the transmission device 70. Two connection ropes 64, 65 are respectively located on the front side and the rear side of each of the slats 63. Multiple support ropes 66 are transversely connected between the two connection ropes 64, 65. The support ropes 66 are respectively located between the slats 63 so as to support the slats 63.

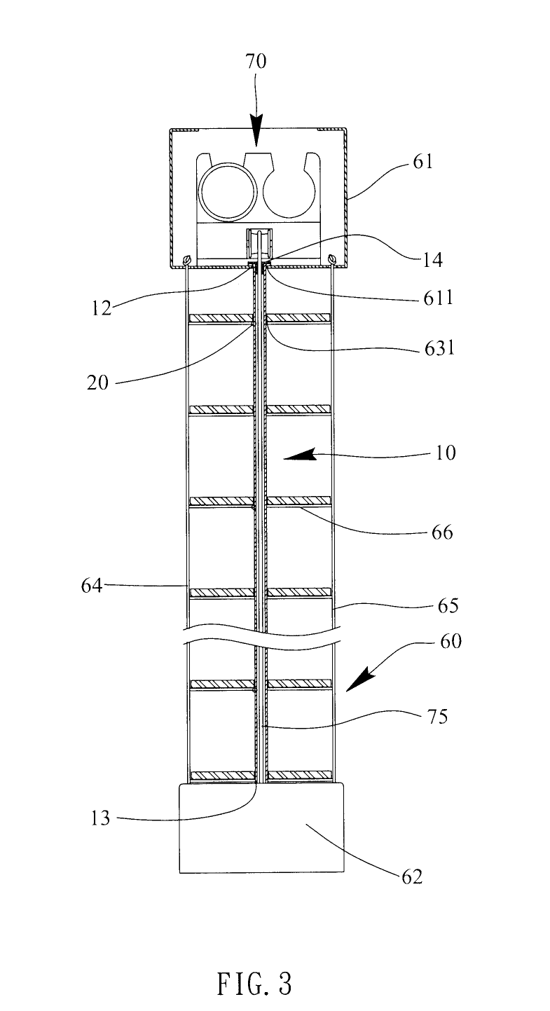

The cord protection sleeve 10 of the present invention comprises a tubular and flexible body and a passage 11 is defined axially through the cord protection sleeve 10. The cord protection sleeve 10 extends through the slats 63 and each of the cords 75 freely extends through the passage 11 of the cord protection sleeve 10 corresponding thereto. The inner diameter of the passage 11 is larger than the outer diameter of the cord 75 so that the cord 75 is freely operated within the passage 11. The cord protection sleeve 10 has a first end 12 and a second end 13, wherein the first end 12 of the cord protection sleeve 10 has a fixing collar 14 connected thereto, the fixing collar 14 is fixed to a hole defined through the head box 61 as shown in FIG. 3 The second end 13 of the cord protection sleeve 10 is fixed to the bottom bar 62. Each of the cord protection sleeves 10 are secured to the support ropes 66. In a preferred embodiment, multiple securing members 20 are connected to outside of the cord protection sleeve 10, and the securing members 20 are connected to the support ropes 66. Different ways for securing the cord protection sleeves 10 to the support ropes 66 are also available, such as adhering or sewing. The cord protection sleeves 10 each are made to fit the length of the blinds so that when the blinds are expanded, the cord protection sleeves 10 are pulled to be straight.

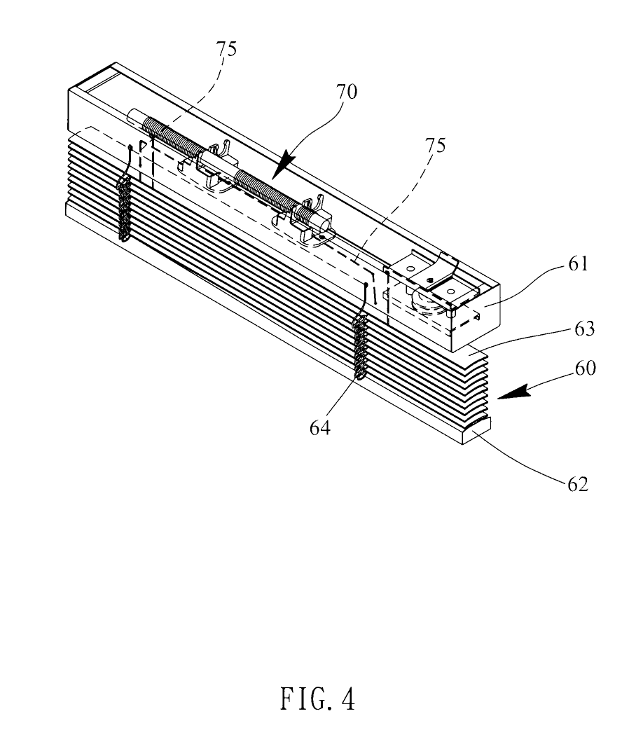

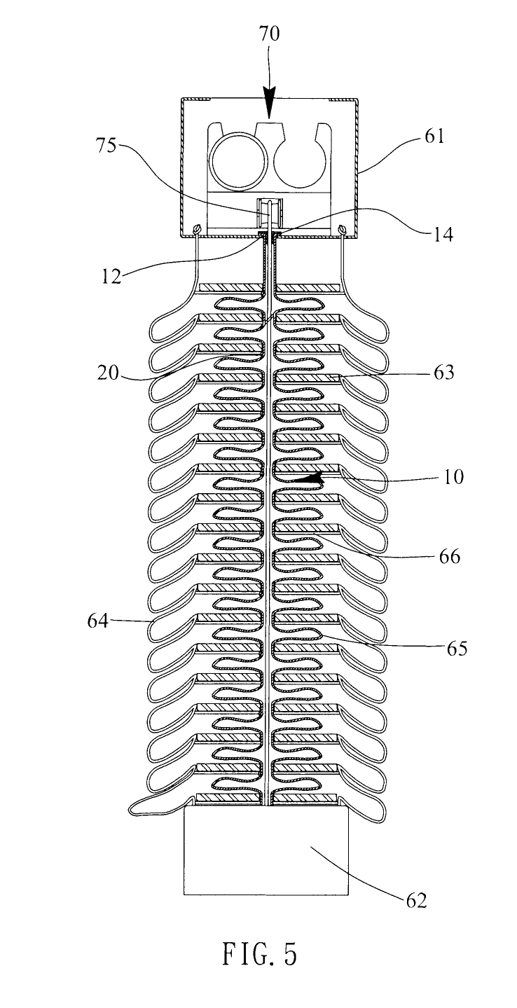

Referring to FIGS. 4 and 5, when the user holds the bottom bar 62 and pushes the bottom bar 62 to collect the slats 63, the cords 75 are pulled upward and the gaps between the slats 63 are shortened. The flexible cord protection sleeves 10 are bent laterally so as to be located between the slats 63. The deformation of the flexible cord protection sleeves 10 do not interfere the operation of the cords 75.

Because the cord protection sleeves 10 are secured to the support ropes 66, they cannot be pulled away from the slats 63, thereby preventing the cords 75 from wrapping around the limbs of kids.

While we have shown and described the embodiment in accordance with the present invention, it should be clear to those skilled in the art that further embodiments may be made without departing from the scope of the present invention.

What is claimed is:

1. A cordless blinds comprising:
a head box and a transmission device received in the head box, multiple slats located between the head box and a bottom bar which is connected with a lowest slat, a cord having a first end connected with the transmission device and a second end of the cord extending through the slats and being fixed to the bottom bar, two connection ropes respectively located on a front side and a rear side of each of the slats, multiple support ropes transversely connected between the two connection ropes, the support ropes respectively located between the slats so as to support the slats, and
a cord protection sleeve comprising a tubular and flexible body and a passage defined axially through the cord protection sleeve, the cord protection sleeve extending through the slats and the cord freely extending through the passage, an inner diameter of the passage being larger than an outer diameter of the cord, the cord protection sleeve having a first end and a second end, the first end fixed to the head box and the second end fixed to the bottom bar, the cord protection sleeve secured to the support ropes.

2. The cordless blinds as claimed in claim 1, wherein the first end of the cord protection sleeve has a fixing collar connected thereto, the fixing collar is fixed to a hole defined through the head box.

3. The cordless blinds as claimed in claim 1, wherein multiple securing members are connected to outside of the cord protection sleeve, the securing members are connected to the support ropes.
